(19) United States
(12) Patent Application Publication
(10) Pub. No.: US 2018/0090174 A1
(43) Pub. Date: Mar. 29, 2018

(54) VIDEO GENERATION OF PROJECT REVISION HISTORY

(71) Applicant: Amazon Technologies, Inc., Seattle, WA (US)

(72) Inventors: Thibaut Labarre, Seattle, WA (US); Chase Hermsen, Seattle, WA (US)

(21) Appl. No.: 15/278,736

(22) Filed: Sep. 28, 2016

(51) Int. Cl. G11B 27/02; G11B 27/34; H04N 21/472; H04N 21/84; H04N 21/854

(52) U.S. Cl. CPC G11B 27/02; G11B 27/34; H04N 21/854; H04N 21/8402; H04N 21/47205

(57) ABSTRACT

Disclosed are various embodiments for generating video content illustrating the iterative development of a project according to the different versions of the project. Versions of unrendered code are obtained from a version control system repository. The text of the unrendered code for the different versions is compared to identify any changes in the visual output of the unrendered code. Snapshots of the rendered versions are captured and modified to highlight any visual output changes that are identified. Video content is generated using the snapshots.

### BACKGROUND

A code-based project can have multiple versions during its development. Differences between the versions may include the addition, deletion, and/or modification of content relative to a prior version. The differences may affect the visual output of the content between versions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting an example scenario related to the generation of video content illustrating the visual development of a project according to the source code versions of the project according to various embodiments of the present disclosure.

FIG. 2 is a drawing of a networked environment according to various embodiments of the present disclosure.

FIGS. 3A, 3B, and 3C are pictorial diagrams of example user interfaces rendered by a client in the networked environment of FIG. 2 according to various embodiments of the present disclosure.

FIGS. 4 and 5 are flowcharts illustrating examples of functionality implemented as portions of a code rendering engine executed in a computing environment in the networked environment of FIG. 2 according to various embodiments of the present disclosure.

FIG. 6 is a flowchart illustrating one example of functionality implemented as portions of a video generator executed in a computing environment in the networked environment of FIG. 2 according to various embodiments of the present disclosure.

FIG. 7 is a flowchart illustrating one example of functionality implemented as portions of a client application executed in a client in the networked environment of FIG. 2 according to various embodiments of the present disclosure.

FIG. 8 is a schematic block diagram that provides one example illustration of a computing environment employed in the networked environment of FIG. 2 according to various embodiments of the present disclosure.

### DETAILED DESCRIPTION

The present disclosure relates to generating video content illustrating the iterative development of non-binary code-based projects that are versioned through a version control system (e.g., GIT®, PERFOURCE®, Concurrent Version System (CVS), subversion, etc.) and stored in a version control system repository. Specifically, snapshots of rendered code (e.g., user interface) for different versions of source code for the project can be converted into video frames and compiled together to generate video content that provides a visual representation of the development history for a project. A project can comprise any non-binary code-based project such as, for example, text documents, diagrams, webpages, presentations (e.g., PowerPoint®), and/or any other type of non-binary code-based project.

In some embodiments of the present disclosure, the text of different versions of unrendered code may be compared to one another to identify any differences in the unrendered code that affect the visual rendered output between versions. In some embodiments, the snapshots may be modified to visually highlight the visual differences between each version of the project. For example, if text is added to a newer version, the text may be displayed in a different color (e.g., green) than the unchanged text. Likewise, if text is removed from a later version, that text may also be displayed in a color (e.g., red) that is different from the unchanged text and/or added text. In some embodiments, the video content may be interactive such that a user selection of a portion of the video content may generate additional information to be displayed.

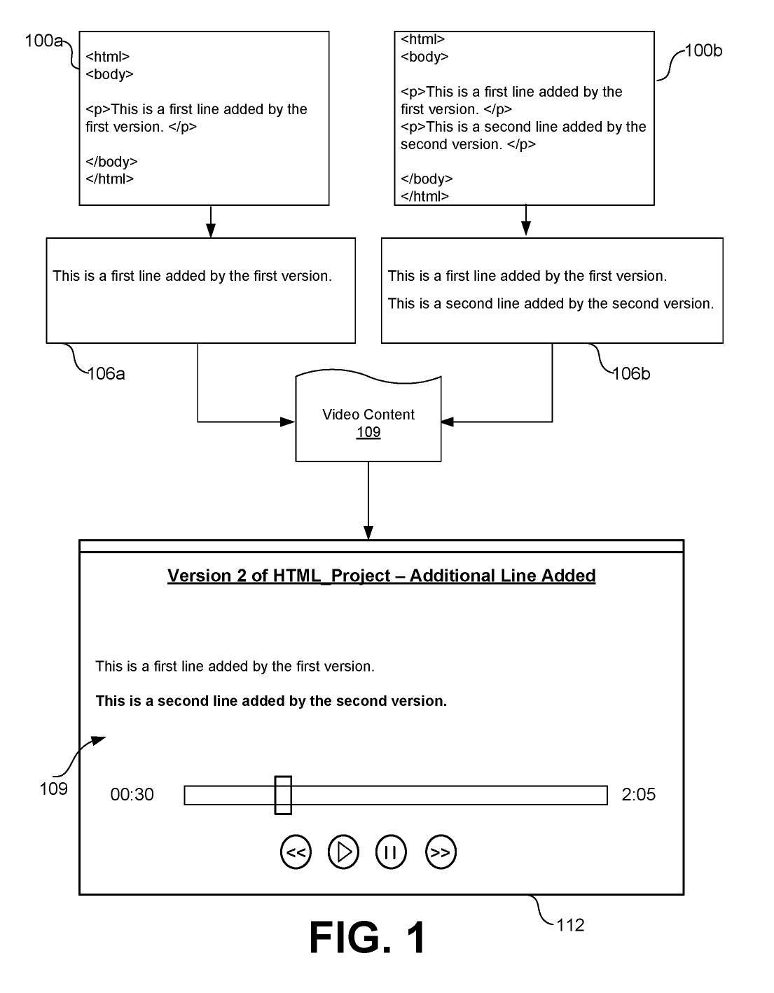

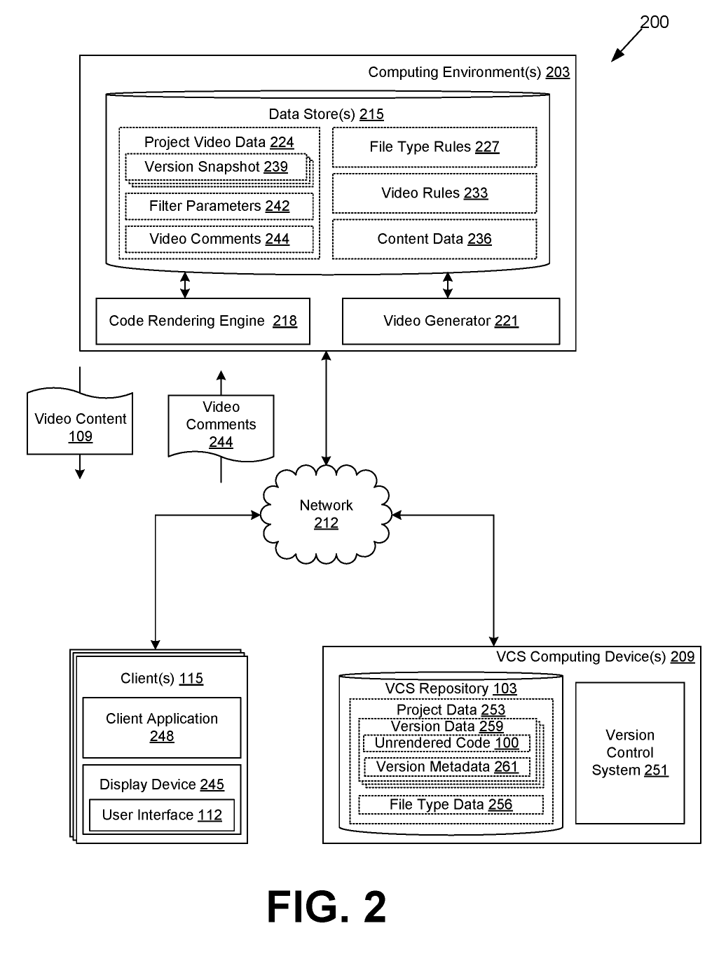

FIG. 1 is a drawing depicting an example scenario related to the generation of video content illustrating the visual development of a project according to the source code versions of the project. Specifically, as shown in FIG. 1, the process begins with accessing different versions of unrendered code 100 (e.g., 100a, 100b) from a version control system (VCS) repository (FIG. 2). For example, in FIG. 1, unrendered code 100a corresponds to an earlier version of the project source code than unrendered code 100b. It should be noted that while unrendered code 100 of FIG. 1 shows the source code for a hypertext markup language (HTML) document, the source code may comprise any type of non-binary source code in which differences between the versions of source code can be identified. For example, the unrendered code 100 may comprise source code corresponding to text documents, diagrams, webpages, presentations (e.g., PowerPoint®), and/or any other type of non-binary source code.

Each version of the unrendered code 100 can be converted to rendered code 106 (e.g., 106a, 106b). Specifically, as shown in FIG. 1, rendered code 106a corresponds to unrendered code 100a and rendered code 106b corresponds to unrendered code 100b. Video content 109 is generated using snapshots of the rendered code 106 that have be converted into video frames. The video content 109 may be generated by appending the video frames of the later versions of rendered code 106 to the former versions of the rendered code 106. For example, the first hundred frames of the video content 109 may show a first version of the rendered code 106, the next fifty frames may correspond to a fading between the first version of the rendered code 106 and the second version of the rendered code 106, and the next one-hundred frames may show the second version of the rendered code 106.

As shown in FIG. 1, a user interface 112 comprising the video content 109 may be rendered by a client 115 (FIG. 2). Accordingly, a user can view the iterative development of a code-based project visually via the rendered video content 109. In some embodiments of the present disclosure, the visual changes may be highlighted within the video content 109. For example, the video content 109 shown in FIG. 1 illustrates the added line (i.e., “This is a second line added by the second version”) in a bold format, even though the unrendered code 100b does not indicate that this line be bolded. In some embodiments, a copy of the unrendered code 100 may be modified such that the rendered versions of the unrendered code 100 visually highlight the changes. In other embodiments, an abstraction layer may be added to a rendered version of the unrendered code 100 to visually highlight the changes. In other embodiments, the abstraction layer may be added during generation of the video content 109 and may be configured to highlight the change between transitions of a video frame corresponding to a first version and a video frame corresponding to a second version (e.g., morphing, fade-in, fade-out, etc.).

In the following discussion, a general description of the system and its components is provided, followed by a discussion of the operation of the same.

With reference to FIG. 2, shown is a networked environment 200 according to various embodiments. The networked environment 200 includes a computing environment 203, a client 115, and a version control system (VCS) computing device 209, which are in data communication with each other via a network 212. The network 212 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 215 that is accessible to the computing environment 203. The data store 215 may be representative of a plurality of data stores 215 as can be appreciated. The data stored in the data store 215, for example, is associated with the operation of the various applications and/or functional entities described below.

The components executed on the computing environment 203, for example, include a code rendering engine 218, a video generator 221, and other applications, services, processes, systems, engines, or functionality not discussed in detail herein. The code rendering engine 218 is executed to convert the unrendered code 100 into rendered code 106 (FIG. 1). The code rendering engine 218 is also executed to compare text in different versions of the unrendered code 100 to identify differences in the visual output shown in the rendered code 106 between the various versions. Further, the code rendering engine 218 can generate snapshots of the unrendered code 100 that can be used as video frames for the video content 109. The video generator 221 is executed to generate the video content 109. For example, the video generator 221 can convert the rendered code 106 into video frames, and the video content 109 can be created by appending each of the video frames to one another such that the video content 109 illustrates the visual iterative process of the project development. The video generator 221 can also encode the video content 109 using Moving Pictures Experts Group (MPEG), High Efficiency Video Coding (HEVC), Flash®, etc.

The data stored in the data store 215 includes, for example, project video data 224, file type rules 227, video rules 233, content data 236, and potentially other data. The project video data 224 is the data associated with a particular project. The project video data 224 includes version snapshots 239, filter parameters 242, video comments 244, and/or other information. The version snapshots 239 include snapshots of the rendered code 106 for each version of the unrendered code 100 that is to be used for a particular project. The filter parameters 242 include parameters that define characteristics of the content to be included in the video content 109. For example, the filter parameters 242 may define parameters associated with, for example, author specific changes (e.g., only show changes of specific author(s)), complexity changes (e.g., major versions, number of lines changed exceed a predefined threshold, etc.), what area of document to view (e.g., above the fold, below the fold, specified page number, specified slide number, specified diagram section, etc.), and/or other parameters. In some embodiments, the filter parameters 242 are predefined. In other embodiments, the filter parameters 242 are provided via user input via a user interface 112 rendered on a client 115.

The video comments 244 may comprise one or more user comments associated with the rendering of the video content 109 by the client 115. For example, the video content 109 may comprise interactive components (e.g., a text entry box, etc.) that allow a user to input video comments 244 regarding the rendered code 106. These video comments 244 may be stored in the data store 215 and accessed by a developer and/or other user for further review. In some embodiments, the video comments 244 may comprise the text entry and a frame number corresponding to the video frame being rendered by the client 115 when the video comment 244 was entered. In other embodiments, the video comments 244 may correspond to a non-textual comment such as, for example, a touchscreen input corresponding to one or more gestures touching the screen (e.g., drawing a circle, writing a comment via touch and/or a stylus device, etc.).

The file type rules 227 include one or more rules used by the code rendering engine 218 when analyzing each version of the unrendered code 100. For example, the unrendered code 100 for an HTML-based project may require different parameters for analysis than the unrendered code 100 for a diagram-based project as can be appreciated. The file type rules 227 may include rules for one or more non-binary-based file types, such as, for example, HTML files, Extensible Markup Language (XML) files, text files, PowerPoint® presentation files, Microsoft Word® files, Visio® files, and/or any other type of non-binary file type. The file type rules 227 can be used by the code rendering engine 218 to analyze and determine differences in the different versions of unrendered code 100.

The video rules 233 comprise rules used by the video generator 221 that define how the video content 109 is to be generated. For example, the video rules 233 may define parameters corresponding to the transition time between video frames, the types of transitions between frames (e.g., fade, wipe, etc.), which components are to be included in the video content (e.g., play component, title component, status bar component, etc.), what type of versions are to be included in the video content 109 (e.g., major versions only, all versions, every three versions, etc.), and/or any other type of rule associated with the generation of the video content 109. The video generator 221 may apply the video rules 233 so that the video content 109 is generated according to the video rules 233. In some embodiments, the video rules 233 are predefined. In other embodiments, the video rules 233 are established via user input on a user interface 112 rendered on a client 115.

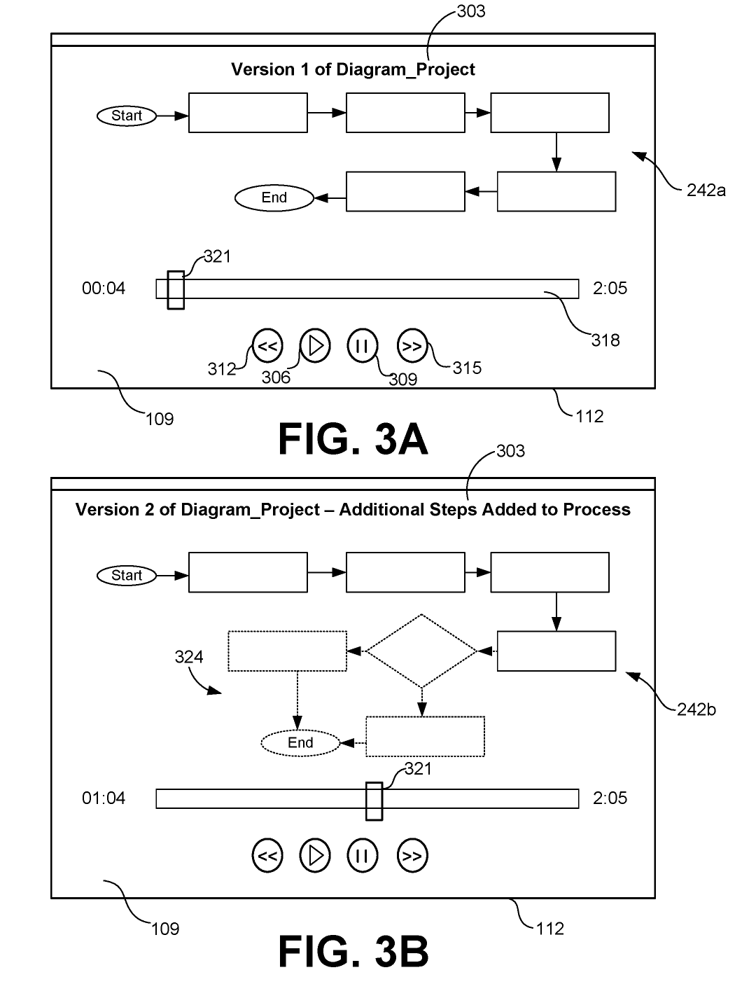

The content data 236 may include images, text, code, graphics, audio, video, and/or other content that may be used by the video generator 221 when generating the video content 109. For example, the content data 236 may include the images and code that correspond to the play component 306 (FIG. 3A).

The client 115 is representative of a plurality of client devices that may be coupled to the network 212. The client 115 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 115 may include a display 245. The display 245 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client 115 may be configured to execute various applications such as a client application 248 and/or other applications. The client application 248 may be executed in a client 115, for example, to access network content served up by the computing environment 203 and/or other servers, thereby rendering a user interface 112 on the display 245. To this end, the client application 248 may comprise, for example, a browser, a dedicated application, etc., and the user interface 112 may comprise a network page, an application screen, etc. The client 115 may be configured to execute applications beyond the client application 248 such as, for example, email applications, social networking applications, word processors, spreadsheets, and/or other applications.

The version control system (VCS) computing device 209 may comprise, for example, a server computer or any other system providing computing capability. The VCS computing device 209 may employ a plurality of computing devices that may be arranged, for example, in one or more server banks or computer banks or other arrangements. Such computing devices may be located in a single installation or may be distributed among many different geographical locations. For example, the VCS computing device 209 may include a plurality of computing devices that together may comprise a hosted computing resource, a grid computing resource and/or any other distributed computing arrangement. In some cases, the VCS computing device 209 may correspond to an elastic computing resource where the allotted capacity of processing, network, storage, or other computing-related resources may vary over time.

Various applications and/or other functionality may be executed in the VCS computing device 209 according to various embodiments. Also, various data is stored in VCS repository 103 that is accessible to the VCS computing device 209. The VCS repository 103 may be representative of a plurality of data stores as can be appreciated. The data stored in the VCS repository 103, for example, is associated with the operation of the various applications and/or functional entities described below.

The VCS computing device 209 may be configured to execute various applications such as a version control system 251 and/or other applications. The version control system 251 may be executed to interact with one or more client applications 248 being executed on one or more clients 115 to store and/or access unrendered code of a project being created via the one or more client applications 248. The version control system 251 may correspond to known version control systems such as, for example, GIT®, PERFORCE®, Concurrent Versions System (CVS), and/or any other type of version control system.

The data stored in the VCS repository 103 includes, for example, project data 253. The project data 253 may include version data 259 and the file type data 256. The version data 259 corresponds to the different versions of a project. The version data 259 includes the unrendered code 100 and the version metadata 261 for each version. The unrendered code 100 comprises the source code associated with the particular version. The version metadata 261 may comprise information corresponding to the unrendered code 100. For example, the version metadata 261 may include source code comments, version number, author data, date of completion, and/or other type of source code metadata as can be appreciated. The file type data 256 is used to indicate the file type associated with the project. For example, the file type may comprise non-binary-based file types, such as, for example, HTML files, Extensible Markup Language (XML) files, text files, PowerPoint® presentation files, Microsoft Word® files, Visio® files, and/or any other type of non-binary file type.

It should be noted that while the version control system 251 and VCS repository 103 are shown in FIG. 2 as being in a distinct computing device that is separate from the computing environment 203, the version control system 251 and the VCS repository 103 may be local to the computing environment 203 as can be appreciated.

Next, a general description of the operation of the various components of the networked environment 200 is provided. To begin, the code rendering engine 218 may receive a request from a client 115 to generate video content 109 that corresponds to the visual development of a project that is stored in the VCS repository 103. The code rendering engine 218 may access the different versions of unrendered code 100 from the VCS repository 103 that correspond to the project. In some embodiments, the code rendering engine 218 may access every version of the unrendered code 106 from the VCS repository 103. In other embodiments, the code rendering engine 218 may access only versions of the unrendered code 100 that comply with the filter parameters 242. For example, the filter parameters 242 may indicate that only major versions of the unrendered code 100 are to be considered. As such, versions “1.0” and “2.0” may be considered while versions “1.1” and “2.1” will not be considered.

After obtaining the different versions of the unrendered code 100, the code rendering engine 218 may render the unrendered code 100 and create a version snapshot 239 for each version of rendered code 106. In some embodiments, the unrendered code 100 may contain an error which could lead to the inability to render the unrendered code 100. If the code rendering engine 218 is unable to render the unrendered code 100, the code rendering engine 218 may take a snapshot of a blank screen. In some embodiments, an abstraction layer may be added to include a dialog box, an error image, an audio, and/or any other type of indicator that could be added to indicate the error in the particular version of the unrendered code 100.

In some embodiments, the unrendered code 100 may be rendered according to one or more views. For example, the unrendered code 100 may comprise above-the-fold views and below-the fold views. As such, the code rendering engine 218 may create the version snapshots 239 according to the different views.

In some embodiments, the code rendering engine 218 may compare the text between different versions of the unrendered code 100 to identify differences that affect the visual output of the unrendered code 100 as displayed via the rendered code 106. For example, assume that version “2.0” of a diagram-based project, includes an additional component. The code rendering engine 218 can identify the addition of the additional component via the comparison of version “2.0” with version “1.0.”

In some embodiments, the code rendering engine 218 only identifies changes according to the filter parameters 242. For example, the filter parameters 242 may indicate that only changes made by a particular author are to be identified. As such, the code rendering engine 218 may ignore changes in the unrendered code 100 that are made by someone other than the specified author. In another non-limiting example, the filter parameters 242 may indicate that only changes between major versions are to be identified. As such, the code rendering engine 218 may only compare the unrendered code 100 between major versions and ignore the minor versions.

In some embodiments, the code rendering engine 218 may compare consecutive versions. In other embodiments, the code rendering engine 218 may compare versions of unrendered code 100 that are not consecutive. For example, the filter parameters 242 may define criteria in which only every three versions are to be compared. As such, assume there are twelve different versions for a particular project. In this non-limiting example, the code rendering engine 218 may compare versions “1” and “3,” versions “3” and “6,” versions “6” and “9,” versions “9” and “12.”

In some embodiments, the code rendering engine 218 compares the unrendered code 100 according to the file type rules 227 associated with the file type of the particular project. As such, the differences in the code can be determined according to the type of code format. For example, the unrendered code 100 for an HTML-based project may require different parameters for analysis than the unrendered code for a diagram-based project as can be appreciated. In some embodiments, the file type for a particular project can be determined according to the file type data 256 that is stored in the VCS repository 103.

In some embodiments, the unrendered code 100 may correspond to a virtual world in which the rendered code 106 corresponds to three-dimensional space rather than two-dimensional space. As such, the code rendering engine 218 may compare the unrendered code 100 between different versions to identify the three-dimensional differences.

In some embodiments, the changes in the unrendered code 100 may correspond to changes that are based on a user input and are therefore, not immediately visible. For example, assume that the differences between two versions of unrendered code 100 occurs in response to a hovering action. In some embodiments, the code rendering engine 218 may emulate the movement of the mouse to initiate the hover action to generate the change. In some embodiments, the code rendering engine 218 may generate a version snapshot 239 of the rendered code 106 illustrating the visual change that is captured following the series of steps required. In other embodiments, the version snapshot 239 may not comprise a still, but rather include a video and/or multiple stills showing the series of steps that have to be performed to activate the change.

In some embodiments, the version snapshots 239 of the rendered code 106 may include visual highlights of the identified changes. The differences may be highlighted via a change in color, an addition of dialog box, a box included over the change, morphing, fade in and/or fade out, dotted lines, a font-type change, a font-size change, a font-style change, a strike-through, an image added relative to a location of the at least one identified change, a sound, and/or any other type of highlight. In some embodiments, a copy of the unrendered code 100 may be modified to include visual highlights for any of the identified changes. In other embodiments, an abstraction layer may be added to the snapshot of the rendered code 106 to visually display the differences identified in the unrendered code 100 between the different versions. For example, assume the change is an added paragraph. In this example, the code rendering engine 218 can identify the location of the change in the rendered code 106 and generate an abstraction layer to draw a box surrounding the added paragraph. In another example, the code rendering engine 218 can determine the font and font size of the paragraph in the rendered code 106 (or snapshot) and generate an abstraction layer that overlays the text of the paragraph in a bolded font. The version snapshot 239 stored in the data store 215 may include the snapshot of the rendered code 106 in addition to the abstraction layer.

After the code rendering engine 218 has created the version snapshots 239 for the video content 109, the video generator 221 may generate the video content 109. In some embodiments, the video generator 221 converts each of the version snapshots 239 into a video frame and adds each frame to one another in consecutive order. In some embodiments, the video content 109 may be generated to include an abstraction layer that provides for visual highlights corresponding to the changes between versions during playback of the video content 109. For example, the abstraction layer may be configured to visually highlight the changes during transitions between a frame of a first version and a frame of a second version (e.g., morphing, fading-in, fading-out, etc.)

In some embodiments, each video frame may comprise a title component 303 which includes information about the particular version associated with the video frame. For example, the title component 303 may recite the version number of the project, identify any changes between the versions, indicate the author(s) associated with the changes, and/or any other information. This information may be included in the version metadata 261. In some embodiments, information included in the version metadata 261 may be converted, via the video generator 221, into an audio signal. Accordingly, the video content 109 may comprise an audio signal that provides sound and/or narration associated with the visual development of the project.

In some embodiments, the video generator 221 may generate the video content 109 to include interactive components, such as for example, a play component 306, a fast forward component 315, a slider component 321, a pause component 309, a hover component, a text entry component 335, and/or any other interactive component as can be appreciated. For example, the video content 109 can be generated such that while the video frame itself does not display information about a change, a user could hover an input device over a particular section of the document which may include a change, and a dialog box may appear that provides additional information about the change. For example, the dialog box may provide comments obtained from the version metadata 261 which may explain the change, the reason for the change, the author of the change, the date of the change, and/or any other information. In some embodiments, the abstraction layer added to the snapshot of the rendered code 106 may provide the interactive functionality.

In some embodiments, the video generator 221 generates the video content 109 according to the video rules 233. For example, the video rules 233 may indicate a transition time between versions, and therefore, more frames will need to be added to the video content 109. In one non-limiting example, the transition time may be based at least in part on the time elapsed between the different versions. In another non-limiting example, the transition time may be based at least in part on the complexity of the versions such that the transition time for a major version may be longer than the transition time for a minor version.

Upon generating the video content 109, the video generator 221 may transmit the video content 109 to the client 115 for playback. In some embodiments, the video content 109 is generated by the video generator 221 as an animation file that can be dynamically rendered on a website. In other embodiments, the video content comprises a video file (e.g., .mpeg).

Turning now to FIG. 3A, shown is one example of the video content 109 rendered via a user interface 112 of a client application 248 executed in a client 115 (FIG. 2) according to various embodiments of the present disclosure. In particular, FIG. 3A depicts a video frame comprising version snapshot 239a in the video content 109 rendered in a user interface 112 being rendered on a client 115 (FIG. 2).

As shown in FIG. 3A, the video content comprises a title component 303, a play component 306, a pause component 309, a rewind component 312, a fast forward component 315, a status bar 318, and a slider bar 321. The title component 303 may be configured to include information about the particular video frame being rendered, such as, for example, project title, version number, changes to project, and/or any other information that can be obtained from the version metadata 261. The play component 306, the pause component 309, the rewind component 312, the fast forward component 315, the status bar 318, and the slider bar 321 may each comprise interactive components as can be appreciated that allow a user to interact with and/or control the playback of the video content 109 being rendered in the user interface 112 by the client 115.

Moving on to FIG. 3B, shown is another example of the video content 109 rendered via a user interface 112 of a client application 248 executed in a client 115 (FIG. 2) according to various embodiments of the present disclosure. In particular, FIG. 3B depicts another video frame of the video content 109 of FIG. 3A. As stated in the title component 303, the video frame of the video content 109 being rendered corresponds to “Version 2” of the particular project. As shown in FIG. 3B, “Version 2” includes additional steps 324 added to the flowchart. The additional steps 324 are shown in dotted lines to highlight the change between versions. While the changes are highlighted by dotted lines, it should be noted that the changes could be highlighted by a change in color, a dialog box, a morphing, a fade-in and/or fade-out, the addition of a box surrounding the changed area, and/or any other type of highlighting.

Turning now to FIG. 3C, shown is shown is another example of the video content 109 rendered via a user interface 112 of a client application 248 executed in a client 115 (FIG. 2) according to various embodiments of the present disclosure. In particular, FIG. 3C depicts the interactive nature of the video content 109 by showing the “Version 2” version snapshot 239 being rendered in the user interface 112 and a mouse component 328 hovering over one of the newly added steps. The hovering of the mouse component 328 over the newly added steps can activate the launching of a dialog box 331 that includes a text-entry component 335. As shown in FIG. 3C, the dialog box 331 may provide more information about the particular version change. The text-entry component 335 allows a user to provide video comments 244.

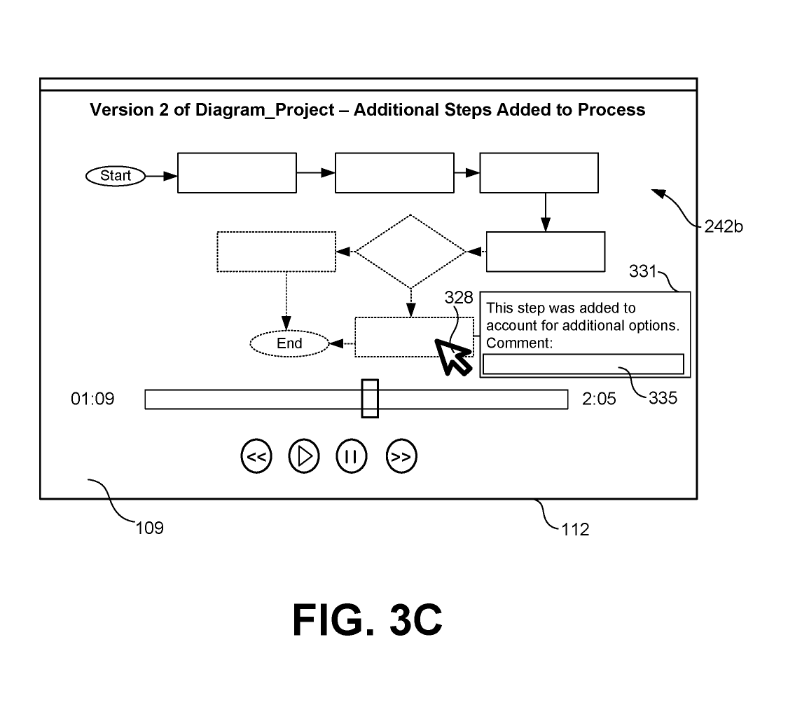

Referring next to FIG. 4, shown is a flowchart that provides one example of the operation of a portion of the code rendering engine 218 according to various embodiments. It is understood that the flowchart of FIG. 4 provides merely an example of the many different types of functional arrangements that may be employed to implement the operation of the portion of the code rendering engine 218 as described herein. As an alternative, the flowchart of FIG. 4 may be viewed as depicting an example of elements of a method implemented in the computing environment 203 (FIG. 2) according to one or more embodiments. FIG. 4 provides a non-limiting example of the functionality that may be performed by the code rendering engine 218 in generating version snapshots 239 of the different versions of the rendered code 106 for a particular project versioned through a version control system 251 and stored in the VCS repository 103.

Beginning with box 403, the code rendering engine 218 accesses a version of unrendered code 100 from the VCS repository 103. In box 406, the code rendering engine 218 can render the version of the unrendered code 100. In some embodiments, the code rendering engine 218 can render the unrendered code 100 in a display device associated with the computing environment 203. In other embodiments, the code rendering engine 218 can render the unrendered code in an emulated display device.

In box 409, the code rendering engine 218 takes a snapshot of the rendered code 106. In box 412, the code rendering engine 218 stores the version snapshot 239 in the data store 215. In box 415, the code rendering engine 218 determines whether there are other versions of the project in the VCS repository 103. If there are other versions in the VCS repository 103, the code rendering engine 218 proceeds to box 403 to access the next version of unrendered code 100 from the VCS repository 103. Otherwise, this portion of the code rendering engine 218 ends.

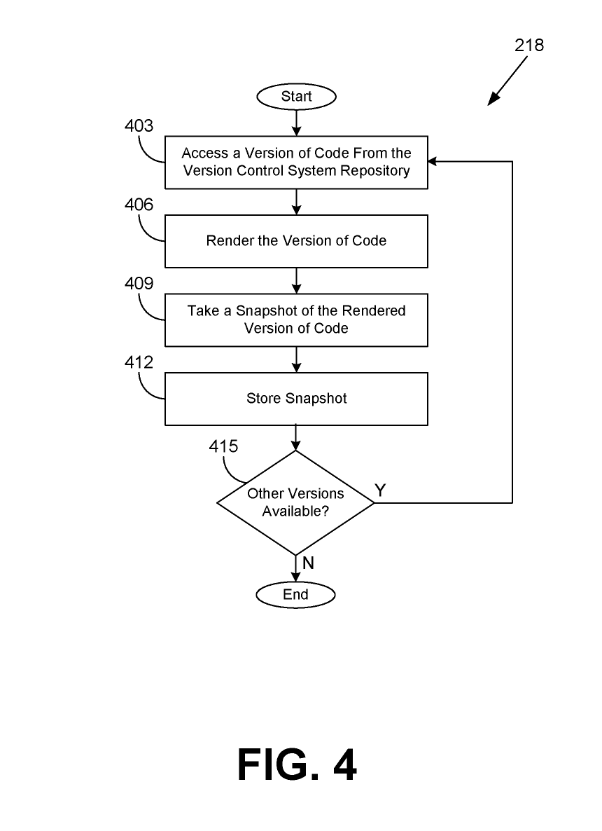

Referring next to FIG. 5, shown is a flowchart that provides one example of the operation of a portion of the code rendering engine 218 according to various embodiments. It is understood that the flowchart of FIG. 5 provides merely an example of the many different types of functional arrangements that may be employed to implement the operation of the portion of the code rendering engine 218 as described herein. As an alternative, the flowchart of FIG. 5 may be viewed as depicting an example of elements of a method implemented in the computing environment 203 (FIG. 2) according to one or more embodiments.

FIG. 5 provides a non-limiting example of the functionality that may be performed by the code rendering engine 218 in generating version snapshots 239 of the different versions of the rendered code 106 for a particular project versioned through a version control system 251 and stored in the VCS repository 103. Specifically, FIG. 5 provides a non-limiting example of creating snapshots of the rendered code that highlight the changes between different versions of the project.

Beginning with box 503, the code rendering engine 218 accesses a copy of a version of unrendered code 100 from the VCS repository 103. In box 506, the code rendering engine 218 determines if accessed copy of unrendered code 100 corresponds to the first version of the project. If the accessed copy of the unrendered code 100 is the first version, the code rendering engine 218 proceeds to box 509 and renders the unrendered code 100. If the accessed copy of the unrendered code 100 is not the first version, the code rendering engine 218 proceeds to box 512.

In box 512, the code rendering engine 218 compares text of the unrendered code 100 of the accessed version with the text of the unrendered code 100 of a previous version to identify any differences in the code that would affect the visual output of the rendered code 106. For example, assume the project is a text-based project. Following a comparison of the second version of the unrendered code 100 with the first version of the unrendered code 100, the code rendering engine 218 may identify a paragraph in the second version that was not included in the first version.

In box 515, the code rendering engine 218 renders the version of the unrendered code 100 to generate the rendered code 106. In box 518, the code rendering engine 218 can generate and add an abstraction layer to the rendered code 106. The abstraction layer can be used to highlight any of the visual changes identified during the comparison of text of the different versions of unrendered code 100. For example, using the example of the added paragraph, the code rendering engine 218 can identify the location on the rendered code 106 where the paragraph is added. The abstraction layer may be generated and added to the rendered code 106 such that a box is added over a newly added paragraph. In some embodiments, the code rendering engine 218 may apply the filter parameters 242 in determining which changes to are to be highlighted. For example, the filter parameters 242 may indicate that only changes made by a particular author are to be included in any version highlights. As such, any identified differences that are associated with the particular author may be noted, while identified visual changes that are associated with another author may be ignored. The author data may be included in the version metadata 261.

In box 521, the code rendering engine 218 takes a snapshot of the rendered code 106. If the rendered code 106 corresponds to the first version, the version snapshot 239 will not have any highlighted changes. If the rendered code 106 corresponds to another version, the version snapshot 239 may include the abstraction layer to visually highlight the visual changes between versions.

In box 524, the code rendering engine 218 stores the version snapshot 239 in the data store 215. In box 527, the code rendering engine 218 determines whether there are additional versions of unrendered code 100 for the project. If there are other versions in the VCS repository 103, the code rendering engine 218 proceeds to box 503. Otherwise, this portion of the code rendering engine 218 ends.

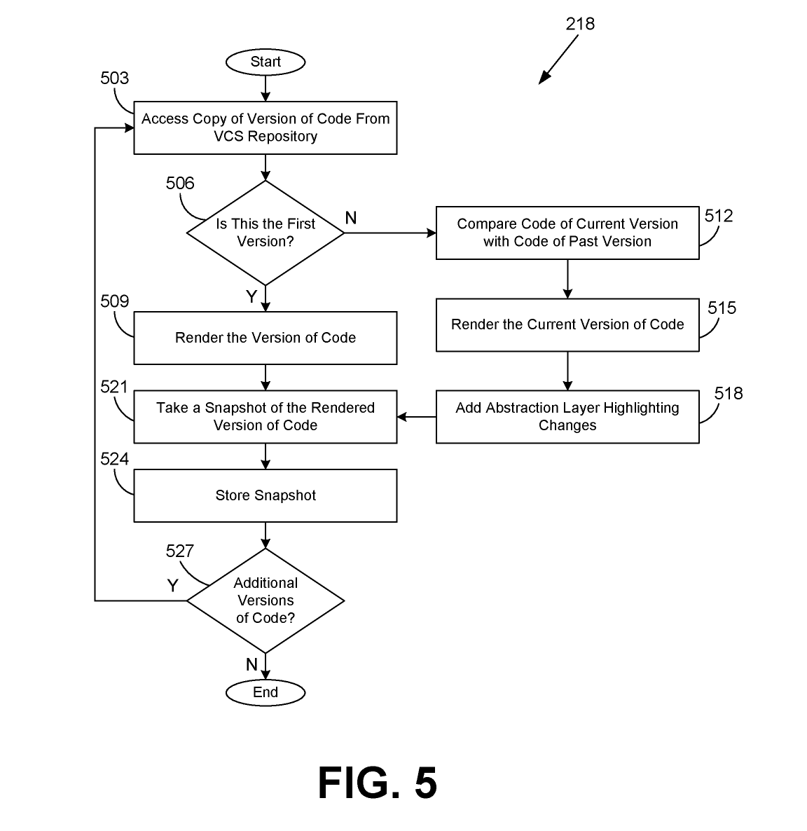

Referring next to FIG. 6, shown is a flowchart that provides one example of the operation of a portion of video generator 221 according to various embodiments. It is understood that the flowchart of FIG. 6 provides merely an example of the many different types of functional arrangements that may be employed to implement the operation of the portion of the video generator 221 as described herein. As an alternative, the flowchart of FIG. 6 may be viewed as depicting an example of elements of a method implemented in the computing environment 203 (FIG. 2) according to one or more embodiments.

FIG. 6 provides a non-limiting example of the functionality that may be performed by the video generator 221 to generate the video content that illustrates the visual changes associated with the version history of a particular project. Specifically, FIG. 6 provides a non-limiting example of how the video content is generated.

Beginning with box 603, the video generator 221 converts the version snapshots 239 into video frames according to various embodiments of the present disclosure. In some embodiments, a video frame may include additional information associated with the corresponding version snapshot 239. For example, a video frame may be generated to include a title component 303 that includes text that may identify the current version. In some embodiments, the title component 303 may comprise additional information that may be identify the changes which have been made.

In box 606, the video generator 221 generates the video content 109 adding the version snapshots 239 as video frames for the video signal. In some embodiments, the video generator 221 may apply the video rules 233 in determining how the video content is to be created. For example, the video rules 233 may include parameters related to the transition time between frames. For example, the transition time between frames may correspond to the amount of time elapsed between versions. In another non-limiting example, the transition time may correspond to the complexity of the versions.

In some embodiments, the video rules 233 may indicate that only video frames corresponding to certain versions are to be included in the video content 109. For example, the video rules 233 may indicate that only versions that are spaced by a predefined number of days are to be included in the video content 109. In one non-limiting example, the video rules 233 may include a rule that states that only versions that are spaced apart by greater than three days are to be included in the video content 109. Accordingly, if version “1.1” of a project was generated the day after version “1.0” was generated, and version “1.2” was generated five days after version “1.0,” the video generator 221 may generate the video signal using the version snapshot 239 associated with version “1.0” and versions “1.2,” while ignoring the version snapshot 239 associated with version “1.1.”

In some embodiments, the video content 109 may comprise additional components associated with the version snapshots 239. For example, the video generator 221 may access the content data 236 for components associated with the playback of the video content 109. For example, the video generator 221 may generate the video content 109 to include a play component 306, a status bar component 318, a slider bar component 321, a pause component 309, a rewind component 312, a fast forward component 315, and/or any other type of component. In box 609, the video generator 221 transmits the video content 109 to a client 115 over the network 212 for rendering by the client application 248.

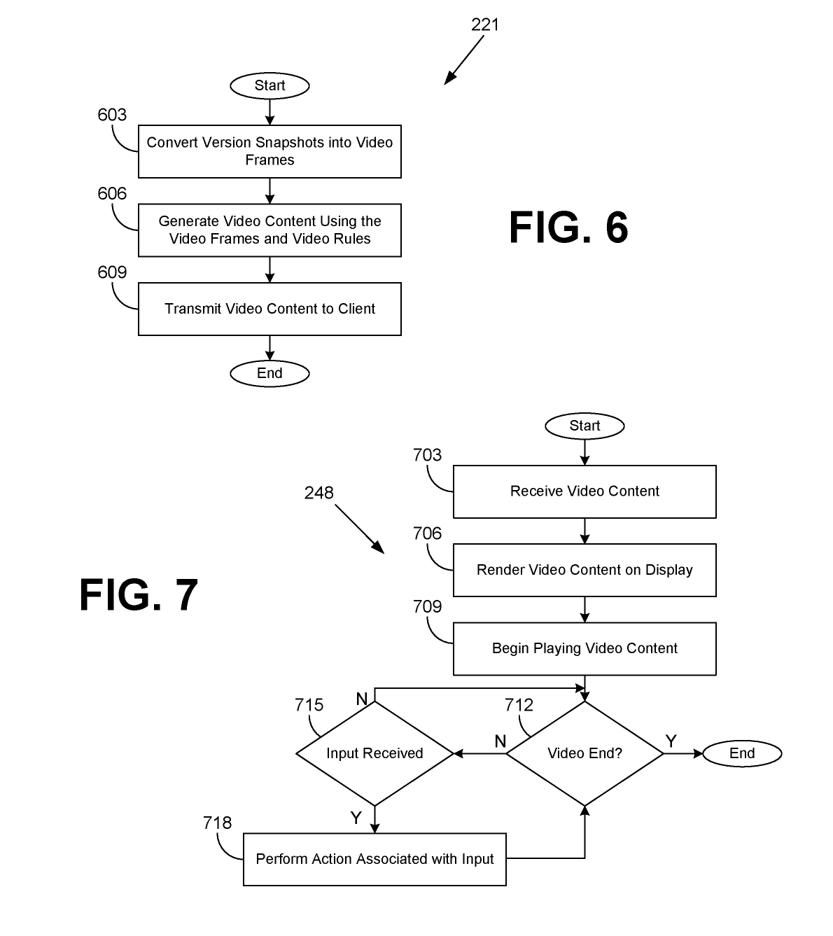

Referring next to FIG. 7, shown is a flowchart that provides one example of the operation of a portion of the client application 248 according to various embodiments. It is understood that the flowchart of FIG. 7 provides merely an example of the many different types of functional arrangements that may be employed to implement the operation of the portion of the client application 248 as described herein. As an alternative, the flowchart of FIG. 7 may be viewed as depicting an example of elements of a method implemented in the client 115(FIG. 2) according to one or more embodiments.

FIG. 7 provides a non-limiting example of the functionality that may be performed by the client application 248 when rendering the video content 109 via the user interface 112. Specifically, FIG. 7 provides a non-limiting example of how a user can interact with the video content via the client application 248.

Beginning with box 703, the client application 248 receives the video content 109 over the network 212 from the video generator 221. In some embodiments, the video content 109 comprises a static video such as, for example, an .mpeg video or other type of video. In other embodiments, the video content 109 comprises a dynamic video that is generated in real-time.

In box 706, the client application 248 renders the user interface 112 including the video content 109 on the display device 245 of the client 115. In box 709, the client application 248 initiates playback of the video content 109. In some embodiments, the client application 248 automatically initiates playback of the video content 109. In other embodiments, the client application 248 initiates playback of the video content 109 in response to a user selection of the play component 306.

In box 712, the client application 248 determines whether playback of the video content 109 has ended. If the video content 109 is complete, the client application 248 ends. Otherwise, the client application 248 proceeds to box 715. In box 715, the client application 248 determines whether an input is received. Inputs may correspond to a selection of the play component 306, a selection of the rewind component 312, a selection of the pause component 309, a selection of the fast-forward component 315, a selection of a video content interactive component, a text entry in a text-entry component 335, and/or any other type of input as can be appreciated. If the client application determines that an input has not been received, the client application 248 proceeds to box 712.

If an input is received, the client application 248 proceeds to box 718 and the client application 248 performs an action associated with the input. For example, if the input corresponds to a text entry in a text-entry component 335, the client application 248 may generate a video comment 244 to transmit for storage in the data store 215 that includes the text entry along with a frame number associated with the video frame being rendered at the time of the receipt of the text entry. In another non-limiting example, the input may correspond to a selection of the pause component. Accordingly, the client application 248 may pause the playback of the video content 109.

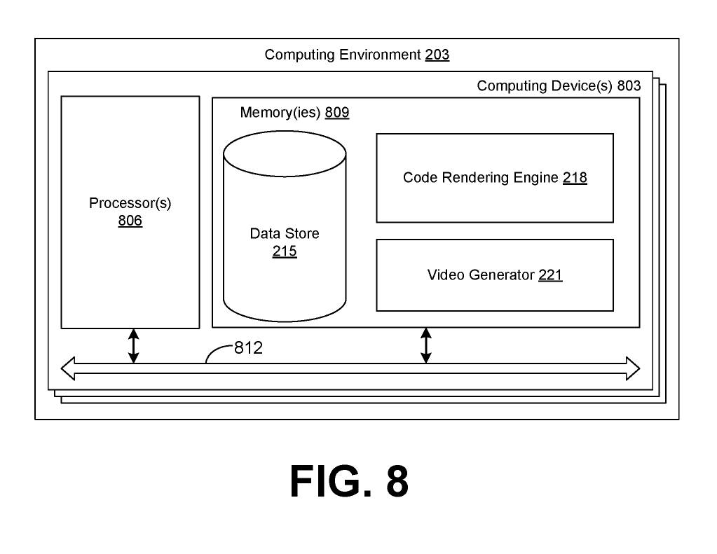

With reference to FIG. 8, shown is a schematic block diagram of the computing environment 203 according to an embodiment of the present disclosure. The computing environment 203 includes one or more computing devices 803. Each computing device 803 includes at least one processor circuit, for example, having a processor 806 and a memory 809, both of which are coupled to a local interface 812. To this end, each computing device 803 may comprise, for example, at least one server computer or like device. The local interface 812 may comprise, for example, a data bus with an accompanying address/control bus or other bus structure as can be appreciated.

Stored in the memory 809 are both data and several components that are executable by the processor 806. In particular, stored in the memory 809 and executable by the processor 806 are the code rendering engine 218, the video generator 221, and potentially other applications. Also stored in the memory 809 may be a data store 215 and other data. In addition, an operating system may be stored in the memory 809 and executable by the processor 806.

It is understood that there may be other applications that are stored in the memory 809 and are executable by the processor 806 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 809 and are executable by the processor 806. In this respect, the term “executable” means a program file that is in a form that can ultimately be run by the processor 806. Examples of executable programs may be, for example, a compiled program that can be translated into machine code in a format that can be loaded into a random access portion of the memory 809 and run by the processor 806, source code that may be expressed in proper format such as object code that is capable of being loaded into a random access portion of the memory 809 and executed by the processor 806, or source code that may be interpreted by another executable program to generate instructions in a random access portion of the memory 809 to be executed by the processor 806, etc. An executable program may be stored in any portion or component of the memory 809 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 809 is defined herein as including both volatile and nonvolatile memory and data storage components. Volatile components are those that do not retain data values upon loss of power. Nonvolatile components are those that retain data upon a loss of power. Thus, the memory 809 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 806 may represent multiple processors 806 and/or multiple processor cores and the memory 809 may represent multiple memories 809 that operate in parallel processing circuits, respectively. In such a case, the local interface 812 may be an appropriate network that facilitates communication between any two of the multiple processors 806, between any processor 806 and any of the memories 809, or between any two of the memories 809, etc. The local interface 812 may comprise additional systems designed to coordinate this communication, including, for example, performing load balancing. The processor 806 may be of electrical or of some other available construction.

Although the code rendering engine 218, the video generator 221, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4, 5, 6, and 7 show the functionality and operation of an implementation of portions of the code rendering engine 218, the video generator 221, and the client application 248. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 806 in a computer system or other system. The machine code may be converted from the source code, etc. If embodied in hardware, each block may represent a circuit or a number of interconnected circuits to implement the specified logical function(s).

Although the flowcharts of FIGS. 4, 5, 6, and 7 a specific order of execution, it is understood that the order of execution may differ from that which is depicted. For example, the order of execution of two or more blocks may be scrambled relative to the order shown. Also, two or more blocks shown in succession in FIGS. 4, 5, 6, and 7 may be executed concurrently or with partial concurrence. Further, in some embodiments, one or more of the blocks shown in FIGS. 4, 5, 6, and 7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the code rendering engine 218 and the video generator 221, that comprises software or code can be embodied in any non-transitory computer-readable medium for use by or in connection with an instruction execution system such as, for example, a processor 806 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the code rendering engine 218 and the video generator 221, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 803, or in multiple computing devices in the same computing environment 203.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium embodying a program executable in at least one computing device, wherein, when executed, the program causes the at least one computing device to at least:
obtain a plurality of versions of unrendered code from a version control system repository;
for individual ones of the plurality of versions of unrendered code,
compare a respective version of unrendered code with a prior version of unrendered code;
identify at least one change between the respective version and the prior version that affects a visual output of the respective version of unrendered code;
generate a rendered version of the respective version of unrendered code;
capture a snapshot of the rendered version of the respective version of unrendered code; and
modify the snapshot to include a visual highlight of the at least one identified change;
generate a video signal comprising a plurality of video frames corresponding to the plurality of versions of unrendered code, individual video frames of the plurality of video frames corresponding to the snapshot of the rendered version of the respective version of unrendered code; and
transmit the video signal to a client device.

2. The non-transitory computer-readable medium of claim 1, wherein generating the video signal further comprises adding the individual video frames to one another in a sequential order corresponding to a version order of the plurality of versions.

3. The non-transitory computer-readable medium of claim 1, wherein, when executed, the program causes the at least one computing device to at least generate an abstraction layer, the snapshot being modified via an addition of the abstraction layer.

4. The non-transitory computer-readable medium of claim 1, wherein the visual highlight comprises at least one of: a color change, a dialog box, a shape surrounding the at least one identified change, a font-type change, a font size change, a font-style, a strike-through, a dotted line, a sound, or an image added relative to a location of the at least one identified change.

5. A system, comprising:
at least one computing device; and
at least one application executable in the at least one computing device, wherein, when executed, the at least one application causes the at least one computing device to at least:
obtain a first version of unrendered code and a second version of unrendered code;
compare the first version of unrendered code with the second version of unrendered code;
identify a change that affects a visual output of the second version of unrendered code in response to comparing the first version with the second version;
generate a first rendered version of the first version of unrendered code and a second rendered version of the second version of unrendered code;
capture a first snapshot of the first rendered version and a second snapshot of the second rendered version; and
generate an abstraction layer configured to visually highlight the change between the first version and the second version.

6. The system of claim 5, wherein the first version of unrendered code and the second version of unrendered code are obtained from a version control system repository.

7. The system of claim 5, wherein, when executed, the at least one application further causes the at least one computing device to at least:
convert the first snapshot to a first video frame and the second snapshot to a second video frame; and
generate a video signal comprising the first video frame and the second video frame.

8. The system of claim 7, wherein a transition time between the first video frame and the second video frame in the video signal is based at least in part on an elapsed time between a first development date of the first version and a second development date of the second version.

9. The system of claim 7, wherein the video signal further comprises the abstraction layer, and the abstraction layer is configured to visually highlight the change via a transition between the first version and the second version according to at least one of: a fading feature or a morphing feature.

10. The system of claim 7, wherein the video signal comprises dynamic video content.

11. The system of claim 5, wherein the first version of unrendered code and the second version of unrendered code correspond to different versions of a code-based project comprising at least one of: a text document, a markup language (ML) document, a diagram document, or a presentation document.

12. The system of claim 5, wherein the at least one application further causes the at least one computing device to at least modify the second snapshot by adding the abstraction layer to highlight the change that affects the visual output of the second version.

13. A method, comprising:
obtaining, via at least one computing device, a version of unrendered code;
generating, via the at least one computing device, a rendered version of the unrendered code;
capturing, via the at least one computing device, a snapshot of the rendered version of the unrendered code;
generating, via the at least one computing device, a video signal comprising the snapshot; and
transmitting, via the at least one computing device, the video signal to a client.

14. The method of claim 13, wherein the version of unrendered code comprises a first version of the unrendered code, and further comprising obtaining, via the at least one computing device, a second version of the unrendered code.

15. The method of claim 14, further comprising:
generating, via the at least one computing device, a second rendered version of the second version of the unrendered code; and
capturing, via the at least one computing device, a second snapshot of the second rendered version,
wherein the video signal further comprises the second snapshot.

16. The method of claim 14, further comprising:
comparing, via the at least one computing device, a first text of the first version of the unrendered code with a second text of the second version of the unrendered code; and
identifying, via the at least one computing device, a change in a visual output of the second version of the unrendered code in response to comparing the first text with the second text.

17. The method of claim 16, further comprising generating, via at least one computing device, an abstraction layer to highlight the change in the visual output of the visual output of the second version.

18. The method of claim 17, further comprising modifying, via at least one computing device, a second snapshot corresponding to the second version of the unrendered code to include the abstraction layer.

19. The method of claim 17, wherein the video signal further comprises the abstraction layer, and the abstraction layer is configured to visually highlight the change between the first version of the unrendered code and the second version of the unrendered code.

20. The method of claim 17, wherein the change is highlighted by at least one of: a color change, a dialog box, a shape surrounding the change, a font-type change, a font size change, a font-style, a strike-through, a dotted line, an image added relative to a location of the change, a sound, a morphing feature, or a fading feature.
